(19) United States
(12) Patent Application Publication
(10) Pub. No.: US 2008/0074895 A1
(43) Pub. Date: Mar. 27, 2008

(54) CONVERTIBLE VEHICLE ROOF HAVING A LAMP

(75) Inventors: Thomas Halbweiss, Remseck (DE); Gunter Kretzmer, Neu-Wulmstorf (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/859,002

(22) Filed: Sep. 21, 2007

(30) Foreign Application Priority Data
Sep. 22, 2006 (DE) 10 2006 044 911.8

(51) Int. Cl. B60Q 1/00; B60J 7/12

(52) U.S. Cl. 362/490; 296/107.01

(57) ABSTRACT

A vehicle roof includes a convertible folding top having roof segments and a C-pillar. The roof segments have an inner roof lining which adjoins the C-pillar. The folding top is movable between a closed position in which the roof segments, the C-pillar, and the inner roof lining are extended and an opened position in which the roof segments, the C-pillar, and the inner roof lining are folded. A lamp is situated in an opening of one of the inner roof lining and the C-pillar. The lamp has a light within a spacing between a lamp housing and a lamp cover.

### CROSS-REFERENCE TO RELATED APPLICATIONS

This application claims foreign priority benefits under 35 U.S.C. § 119(a)-(d) to DE 10 2006 044 911.8, filed Sep. 22, 2006, which is hereby incorporated by reference in its entirety.

### BACKGROUND OF THE INVENTION

1. Field of the Invention

The present invention relates to convertible vehicle roofs having lamps.

2. Background Art

Vehicle lamps function as reading lights, interior lights, ambient lights, etc. Such lamps are installed in various locations such as on roof consoles, rearview mirrors, and vehicle interior parts.

DE 103 45 003 A1 describes a lamp located between the roof lining and the roof of a vehicle for providing interior light. A reflector reflects light from the lamp to a lens which emits the light through a transparent material into the passenger compartment to illuminate the vehicle interior. An additional lamp located behind the roof lining and having focused light emissions functions as a reading light. Both lamps switch on at the same time.

DE 103 20 614 A1 describes a cover for closing an opening in a vehicle roof. The cover has a panel and a lamp for lighting the vehicle interior. The panel includes a transparent plate having recesses into which light can project. Use of the transparent plate allows requirements to be met as a result of the continuity of the spherical surface. By use of the transparent plate and a transparent panel, outside light may pass through the cover into the passenger compartment.

DE 101 01 450 A1 describes a vehicle interior lighting system having a lamp. The lamp is located in a cavity in the edge region of a vehicle roof with respect to a body element between the roof outer skin and the inner material covering. The lamp radiates light through grid-like openings in the covering into the passenger compartment.

### SUMMARY OF THE INVENTION

An object of the present invention includes a convertible vehicle roof having a lamp for illuminating the vehicle passenger compartment in which the lamp is configured for mounting on the movable roof parts and has a small installation height. A further aim is to achieve functionally reliable operation of the lamp with defined positioning and illumination of the lamp as a result of the roof being moved between closed and opened positions.

In carrying out the above object and other objects, the present invention provides a vehicle roof having a convertible folding top and a lamp. The folding top has roof segments and a C-pillar. The roof segments have an inner roof lining which adjoins the C-pillar. The folding top is movable between a closed position in which the roof segments, the C-pillar, and the inner roof lining are extended and an opened position in which the roof segments, the C-pillar, and the inner roof lining are folded. The lamp has a light within a spacing between a lamp housing and a lamp cover. The lamp is situated in an opening of one of the inner roof lining and the C-pillar.

Further, in carrying out the above object and other objects, the present invention provides a vehicle having a roof and a lamp. The roof has a convertible folding top and a C-pillar. The folding top has movable roof segments and the C-pillar has movable frame sections. The folding top and the C-pillar are movable together between a closed position of the roof in which the roof segments extend over and cover the vehicle interior with the C-pillar frame sections adjoining a respective one of the roof segments and an opened position of the roof in which the roof segments and the C-pillar frame sections are folded in a compact position and stored in a trunk. The lamp has a light within a spacing between a lamp housing and a lamp cover. The lamp is situated in an opening of one of a roof part and a C-pillar frame section to face and illuminate the passenger compartment in the closed position of the roof and to face and illuminate the trunk in the opened position of the roof.

In different embodiments, the lamp is attached to the C-pillar or is in a component covering the C-pillar; the lamp is situated in the inner roof lining and is connected to the C-pillar by a retaining element; and the light cover is flush with the opening.

In an embodiment, the lamp is situated in an opening of the inner roof lining with the light cover connected as one piece to the inner roof lining. In an embodiment, the lamp is situated in an opening of the C-pillar with the light cover connected as one piece to the C-pillar.

The light of the lamp may include an LED, lighting bulbs, an electro-luminescent film, and the like. The lamp assumes the function of a trunk light when the folding top is in the opened position. The lamp may be at least one of an ambient light, a reading light, and an interior light.

The lamp has a very flat design for any given shape as the available space in the inner roof lining or a longitudinal frame section of the C-pillar for installing the lamp is extremely limited. The longitudinal frame sections are profiled elements generally provided with materials or very thin-walled cover parts. The available installation space in the region of the inner roof lining is also limited, since clamping elements and/or elements of a roof kinematic system for moving the folding top are situated behind the inner roof lining.

High safety requirements are imposed on the operational reliability of a lamp in a movable part such as a movable roof part. Movable parts such as control rods, tension brackets, or articulated joints limit the safe guiding of electrical lamp cables. There is a risk of buckling or disconnection of the cables. In addition, the cables and the lamp may be damaged when the roof is collapsed in the opened position. In this case the lamp must be kept in a safe position, in which mobility may be provided during folding of the inner roof lining, or in the collapsed state by multiple roof segments being superposed. These requirements may be met by installing the lamp on a longitudinal frame section such as the C-pillar, for example, or by installing the lamp mounting in the inner roof lining via a retaining element attached to the C-pillar. One or more lamps may be installed at any given location of the inner roof lining and/or a longitudinal frame section of the C-pillar.

When passengers exit or enter the vehicle, the lamp operates as a bright interior or ambient light. During operation of the vehicle the lamp may function as dim ambient lighting to illuminate the dark rear corner regions of the vehicle roof.

A lamp design having a film lighting element is suited for installation of the lamp in a longitudinal frame section of the C-pillar. The longitudinal frame sections of the C-pillar may include a closed profile in which corresponding lamp attachments may be provided during manufacture. The use of lamps having a flat design allows regions, which heretofore did not permit lighting due to the limited installation space, to be used for lighting devices.

A lamp mounted in such a manner may assume other lighting functions such as a reading light. In the opened roof position, the folding top is folded and stored in the rear region of the vehicle such as in the trunk. In this position of the folding top, the lamp may be used as a trunk light or at least for additional illumination of certain regions of the trunk.

The positioning of the lamp in the region of a longitudinal frame section of a C-pillar and/or in the inner roof lining has no interfering effects on the folded-up and stored position of the vehicle roof, thereby reliably preventing rattling noises.

The above features, and other features and advantages of the present invention as readily apparent from the following detailed descriptions thereof when taken in connection with the accompanying drawings.

### BRIEF DESCRIPTION OF THE DRAWINGS

FIG. 1 illustrates a convertible folding top and a C-pillar of a vehicle roof with a lamp facing the passenger compartment mounted on the C-pillar in accordance with an embodiment of the present invention in which the inner roof lining of the folding top is not shown;

FIG. 2 illustrates the folding top and the C-pillar of the vehicle roof with the lamp facing the passenger compartment mounted on the C-pillar as shown in FIG. 1 with the inner roof lining of the folding top being shown;

FIG. 3 illustrates a convertible folding top and a C-pillar of a vehicle roof with a lamp facing the passenger compartment mounted on the inner roof lining of the folding top close to the C-pillar in accordance with an embodiment of the present invention;

FIG. 4 illustrates a cross-sectional view of a lamp having a plurality of individual lights in accordance with an embodiment of the present invention; and

FIG. 5 illustrates a cross-sectional view of a lamp having an electro-luminescent film as a light in accordance with an embodiment of the present invention.

### DETAILED DESCRIPTION OF THE PREFERRED EMBODIMENT(S)

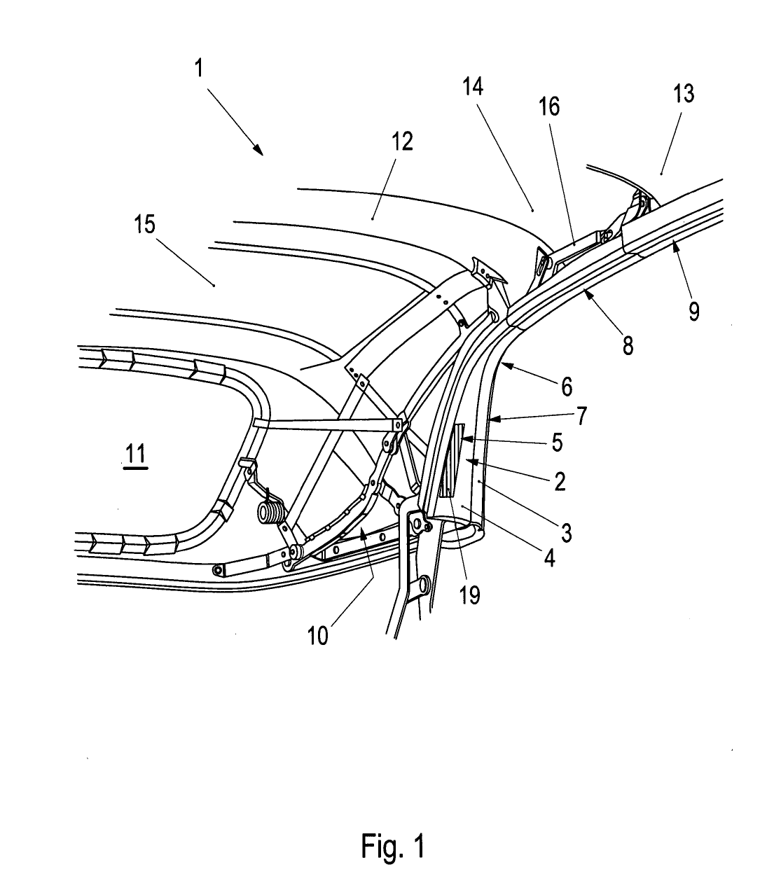

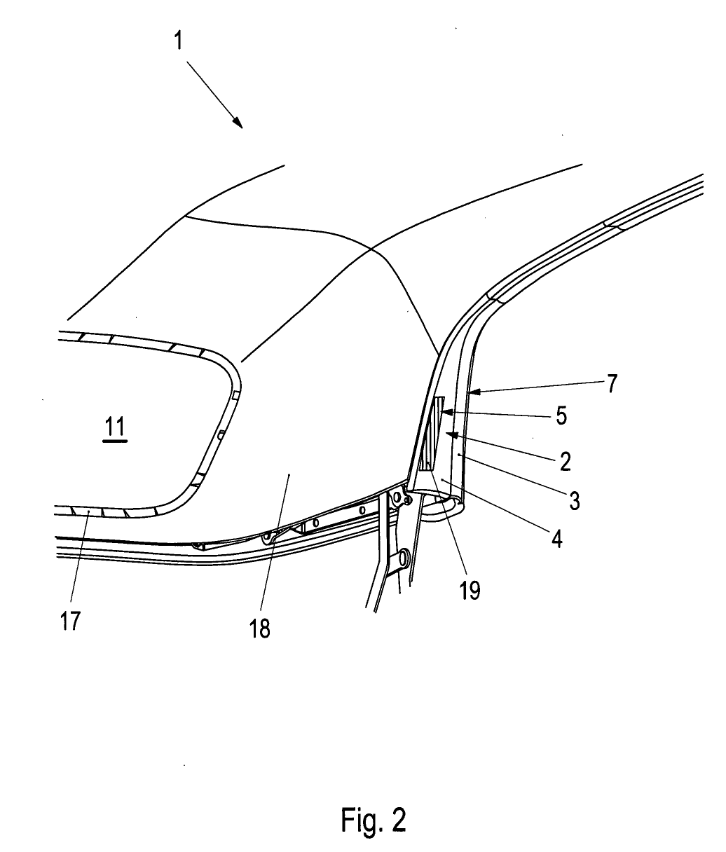

Referring now to FIGS. 1 and 2, a convertible folding top 12 and a C-pillar 2 of a vehicle roof 1 having a lamp 5 in accordance with an embodiment of the present invention is shown. Folding top 12 includes front, middle, and rear roof segments 13, 14, 15 having an inner roof lining 18. Roof segments 13, 14, 15 are movable between a closed position of roof 1 in which folding top 12 with inner roof lining 18 covers the vehicle interior and an opened position of roof 1 in which folding top 12 is folded with roof segments 13, 14, 15 stacked on top of one another and stored in a rear compartment such as a trunk of the vehicle. C-pillar 2 also moves correspondingly between the closed and opened positions of roof 1. In FIGS. 1 and 2, folding top 12 is in the closed position covering the vehicle interior. FIG. 1 illustrates folding top 12 without inner roof lining 18 whereas FIG. 2 illustrates folding top 12 with inner roof lining 18.

Lamp 5 is mounted on C-pillar 2 and faces the passenger compartment of the vehicle interior. Lamp 5 is situated on the roof side facing the passenger compartment in a lower region 4 of C-pillar 2 near vehicle body. Lamp is situated into a recess in C-pillar 2. The recess corresponds to the lamp geometry. Lamp 5 is fastened to C-pillar via fasteners such as screws or clips. C-pillar 2 may be manufactured as a cast part having a profile such as a U-profile open on one side.

When lamp 5 is installed on C-pillar 2, a light cover 19 of lamp 5 is adapted to the profile of C-pillar 2. Light cover 19 in its edge region makes flush contact with C-pillar 2. Light cover 19 may be made of a transparent plastic having a diffuse surface coating. Instead of the surface coating, light cover 19 may be equipped on at least one side with a lens such as a Fresnel lens. By use of such a lens the light emitted from a light source 21 of lamp 5 may be emitted in predetermined directions in a focused or divergent manner.

Lamp 5 may also be a component of a covering for C-pillar 2. Light cover 19 may be designed as one piece with the covering.

In this embodiment, C-pillar 2 is a segment of a lateral longitudinal frame 6 having frame sections 3, 7, 8, 9. Longitudinal frame 6 forms the transition region between folding top 12 and the side windows of the vehicle. Lamp 5 may also be inserted in any other longitudinal frame section 7, 8, 9 other than frame section 3. This embodiment shows folding top 12 in which C-pillar 2 forms rear longitudinal frame section 7.

When the folding top 12 is folded into its opened position, individual longitudinal frame sections 3, 7, 8, 9 are correspondingly collapsed into a compactly folded package corresponding to the specified motion sequences. This package is stored in the rear region or trunk of the vehicle during the opening motion sequences.

Rear roof segment 15 includes a rear window 11. Rear window 11 and roof segments 13, 14, 15 may come to rest on top of one another in such a way that C-pillar 2 may remain uncovered in the region of lamp 5. This is important when lamp 5 projects into the trunk of the vehicle in the opened position of folding top 12 and at the same time is intended to serve as a trunk light.

Lamp 5 may be controlled by limit switches for folding top 12 or by sensors associated with a roof kinematic system 10. Roof kinematic system 10 is operable for moving roof 1 between the closed and opened positions. Electrical connecting cables 23 for lamp 5 may be guided at the interior of folding top 12 in suitable mountings along roof kinematic system 10.

Lamp 5 is advantageously positioned in C-pillar 2 close to folding top 12 as the region between rear window 11 and C-pillar 2 is the rear corner region of roof 1 in which little light from the outside can penetrate. This region is particularly dark and an aim, among others, is to illuminate this region by use of lamp 5 situated in the vicinity. In addition, depending on the positioning of lamp 5 in C-pillar 2, when used as a reading light, lamp 5 is situated close to the passengers resulting in good task-oriented lighting.

When lamp 5 is used in another longitudinal frame section, electrical connecting cables 23 are guided at the inner side of folding top 12 or along roof kinematic system 10.

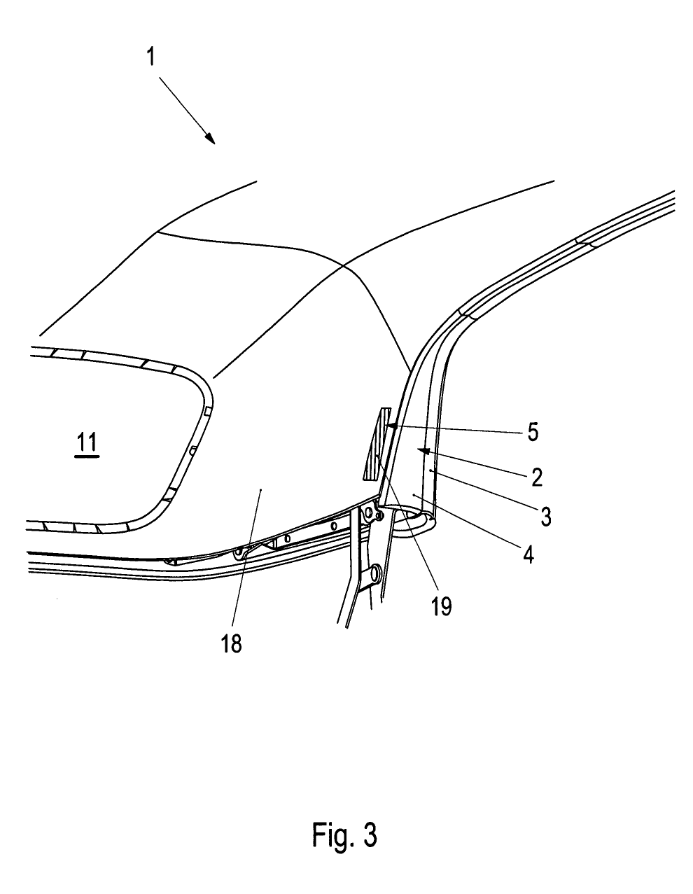

Referring now to FIG. 3, a convertible folding top 12 and a C-pillar 2 of a vehicle roof 1 having a lamp 5 in accordance with an embodiment of the present invention is shown. Lamp 5 faces the passenger compartment and is mounted on inner roof lining 18 of folding top 12 close to C-pillar 2. This embodiment is suitable when C-pillar 2 or longitudinal frame sections 3, 7, 8, 9 are too narrow for lamp 5 to mount onto. As such, lamp 5 is positioned in the region of inner roof lining 18. Light cover 19 of lamp 5 conforms to the contour of inner roof lining 18 and is installed flush with inner roof lining 18. In this case, lamp 5 may be integrated in inner roof lining 18 by clips or other suitable fastenings. This illustration does not show that lamp 5 is fixed in place in inner roof lining 18 by a retaining device fixedly connected to C-pillar 2.

This design has the advantage that lamp 5 remains in the same position with respect to C-pillar 2 when folding top 12 moves, thus preventing damage as the result of possible bends or kinks in inner roof lining 18. The guiding and fastening of the cables is simplified, thus ensuring reliable functioning of lamp 5. Furthermore, it is easier and more economical to support lamp 5 by a retaining element connected to C-pillar 2, compared to positioning lamp 5 on the material of inner roof lining 18 by use of complicated auxiliary means and fastenings. The latter described attachment has the additional disadvantage that a defined lamp position, and thus a fixed predetermined direction of light radiation 24, is not ensured by the flexible positioning in inner roof lining 18. Such a positioning in inner roof lining 18 of a vehicle does not allow vibration-free mounting of lamps 5. Therefore, as previously described the connection to C-pillar 2 or to a rigid, non-vibrating component via suitable mountings is advantageous.

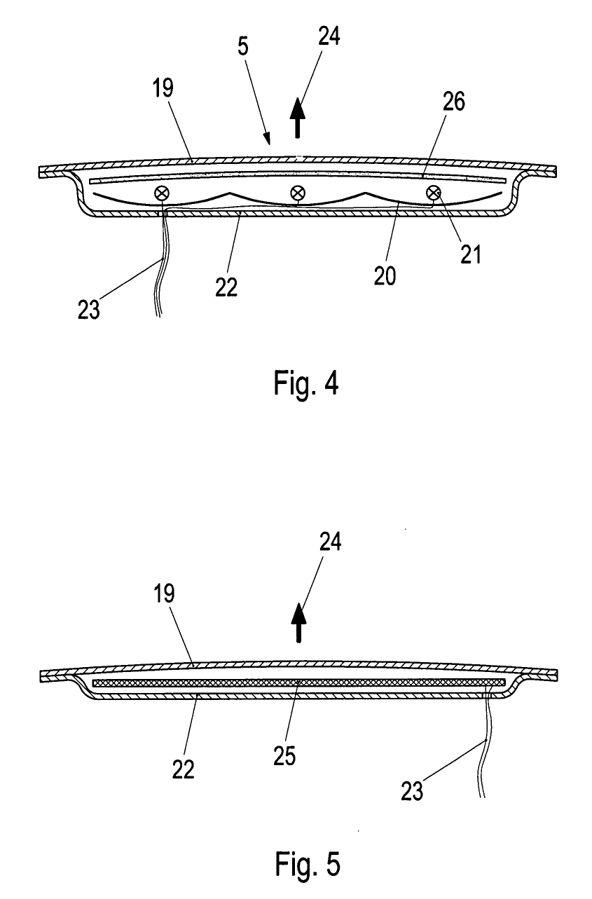

Lamp 5 may have a design such as the designs shown in FIGS. 4 and 5. FIG. 4 illustrates lamp 5 having incandescent light bulbs 21 between a lamp housing 22 and a light cover 19. Light cover 19 and lamp housing 22 are closely connected to one another with an interior space therebetween for accommodating light bulbs 21 (such as LEDs), reflectors 20, and/or additional lenses 26. Light is radiated by at least one lighting bulb 21 onto a reflector 20 which reflects the light outward through light cover 19 in the direction of light radiation 24. Light cover 19 may have optical structures mounted on one or both sides. The radiating light may thus be reflected in one or more desired directions. Lens 26 may be positioned as a lens panel between reflector 20 and light bulbs 21 and light cover 19. Electrical connecting lines 23 are guided outward from lamp housing 22 in the rear region.

FIG. 5 illustrates lamp 5 having an electro-luminescent film 25 for generating light. In this design, in a manner analogous to FIG. 4, lamp 5 is formed from a lamp housing 22 and a light cover 19. Film 25 is provided as lighting in the interior space formed by lamp housing 22 and light cover 19. Film 25 may be applied on the inner side of light cover 19 as well as on the inner side of lamp housing 22. This may be achieved by use of retaining elements or adhesives, for example, and with an appropriate design of the height of the interior space, film 25 is able to fill this space precisely and securely. In this design it is advantageous that film 25 may be flexed in all directions, and therefore may be adapted to any change in the contour of C-pillar 2 or inner roof lining 18. Further, the small installation depth and the low weight are important as flat lamp 5 does not significantly limit the extremely confined space in folding top 12 when folded in the opened position.

Lamp 5 as shown in FIGS. 4 and 5 may be used as a reading light and/or an interior light for exiting or entering the vehicle. Lamp 5 may also be used in the dark rear region as area lighting and/or ambient lighting. Lamp 5 may be incorporated into folding top 12 or inner roof lining 18 by use of adhesives, clamps, or other common fastening means.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A vehicle roof comprising:
a convertible folding top having a plurality of roof segments and a C-pillar, the roof segments having an inner roof lining which adjoins the C-pillar, the folding top movable between a closed position in which the roof segments, the C-pillar, and the inner roof lining are extended and an opened position in which the roof segments, the C-pillar, and the inner roof lining are folded; and
a lamp having a light within a spacing between a lamp housing and a lamp cover, the lamp being situated in an opening of one of the inner roof lining and the C-pillar.

2. The roof of claim 1 wherein:
the lamp is attached to the C-pillar.

3. The roof of claim 1 wherein:
the lamp is in a component covering the C-pillar.

4. The roof of claim 1 wherein:
the lamp is situated in the inner roof lining and is connected to the C-pillar by a retaining element.

5. The roof of claim 1 wherein:
the lamp is situated in the inner roof lining with the light cover being flush with the opening.

6. The roof of claim 1 wherein:
the lamp is situated in the C-pillar with the light cover being flush with the opening.

7. The roof of claim 1 wherein:
the lamp is situated in an opening of the inner roof lining with the light cover connected as one piece to the inner roof lining.

8. The roof of claim 1 wherein:
the lamp is situated in an opening of the C-pillar with the light cover connected as one piece to the C-pillar.

9. The roof of claim 1 wherein:
the light of the lamp is an LED.

10. The roof of claim 1 wherein:
the light of the lamp is an electro-luminescent film.

11. The roof of claim 1 wherein:
the lamp assumes the function of a trunk light when the folding top is in the opened position.

12. The roof of claim 1 wherein:
the lamp is at least one of an ambient light, a reading light, and an interior light.

13. A vehicle comprising:
a roof having a convertible folding top and a C-pillar, the folding top having a plurality of movable roof segments and the C-pillar having a plurality of movable frame sections, wherein the folding top and the C-pillar are movable together between a closed position of the roof in which the roof segments extend over and cover the vehicle interior with the C-pillar frame sections adjoining a respective one of the roof segments and an opened position of the roof in which the roof segments and the C-pillar frame sections are folded in a compact position and stored in a trunk; and
a lamp having a light within a spacing between a lamp housing and a lamp cover, the lamp being situated in an opening of one of a roof part and a C-pillar frame section to face and illuminate the passenger compartment in the closed position of the roof and to face and illuminate the trunk in the opened position of the roof.

14. The vehicle of claim 13 wherein:
the roof segments include an inner roof lining, wherein the lamp is situated in the inner roof lining of a roof part.

15. The vehicle of claim 14 wherein:
the lamp is connected to a C-pillar frame section by a retaining element.

16. The vehicle of claim 13 wherein:
the light cover is flush with the opening.

17. The vehicle of claim 13 wherein:
the lamp is connected as one piece to the one of a roof part and a C-pillar frame section.

18. The vehicle of claim 13 wherein:
the light of the lamp includes an LED.

19. The vehicle of claim 13 wherein:
the light of the lamp includes an electro-luminescent film.

20. The vehicle of claim 13 wherein:
the light of the lamp includes a of light bulb.
